(19) United States
(12) Patent Application Publication
(10) Pub. No.: US 2025/0117321 A1
(43) Pub. Date: Apr. 10, 2025

(54) COMPRESSION-BASED ADDRESS MAPPING MANAGEMENT IN A MEMORY SYSTEM

(71) Applicant: Micron Technology, Inc., Boise, ID (US)

(72) Inventors: Deping He, Boise, ID (US); Wenjun Wu, Shanghai (CN)

(21) Appl. No.: 18/771,713

(22) Filed: Jul. 12, 2024

Related U.S. Application Data
(60) Provisional application No. 63/588,659, filed on Oct. 6, 2023.

(51) Int. Cl. G06F 12/02; G06F 12/06

(52) U.S. Cl. CPC G06F 12/0246; G06F 12/0653

(57) ABSTRACT

Methods, systems, and devices for compression-based address mapping management in a memory system are described. A memory system may reduce a quantity of times regions of an address mapping table are transferred between a non-volatile memory and a local memory of the memory system. The memory system may selectively retain regions of the address mapping table in local memory in-between checkpoint procedures. During a checkpoint procedure, the memory system may compress the regions of the address mapping table in the local memory and, if the regions are sufficiently compressible, may keep the regions in the local memory until the next checkpoint procedure.

### CROSS REFERENCE

The present Application for Patent claims priority to U.S. Patent Application No. 63/588,659 by He et al., entitled “COMPRESSION-BASED ADDRESS MAPPING MANAGEMENT IN A MEMORY SYSTEM,” filed Oct. 6, 2023, which is assigned to the assignee hereof, and which is expressly incorporated by reference in its entirety herein.

### TECHNICAL FIELD

The following relates to one or more systems for memory, including compression-based address mapping management in a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports compression-based address mapping management in a memory system in accordance with examples as disclosed herein.

FIG. 2 shows an example of a system that supports compression-based address mapping management in a memory system in accordance with examples as disclosed herein.

FIG. 3 shows an example of a process flow that supports compression-based address mapping management in a memory system in accordance with examples as disclosed herein.

FIG. 4 shows a block diagram of a memory system that supports compression-based address mapping management in a memory system in accordance with examples as disclosed herein.

FIG. 5 shows a flowchart illustrating a method or methods that support compression-based address mapping management in a memory system in accordance with examples as disclosed herein.

### DETAILED DESCRIPTION

A memory system may use an address mapping table to translate logical addresses (which may be used by a host system) into physical addresses (which may be used by the memory system), and vice versa. As the memory system writes host data to memory, the memory system may update regions of the address mapping table to reflect the physical addresses mapped to the logical addresses associated with the data. To do so, the memory system may perform a checkpoint procedure in which the memory system retrieves regions of the address mapping table from a non-volatile memory, updates the regions with physical address information in a local memory, then returns (or “flushes”) the updated regions to the non-volatile memory. But returning the regions to the non-volatile memory may be a time-consuming process that interferes with or delays other memory access procedures at the non-volatile memory, among other disadvantages.

According to the techniques described herein, a memory system may reduce the number of times regions of an address mapping table are returned to the non-volatile memory by selectively retaining regions of the address mapping table in local memory in-between checkpoint procedures. During a checkpoint procedure, the memory system may compress the regions of the address mapping table in the local memory and, if the regions are sufficiently compressible, may cache the regions (e.g., refrain from returning to the non-volatile memory) until the next checkpoint procedure. By caching regions in the local memory between checkpoint procedures, the memory system may reduce the quantity of times regions of the address mapping table are returned to the non-volatile memory, which may reduce overhead. Retention of compressed regions in the local memory may also allow the memory system to avoid multiple retrievals of the same regions, among other advantages.

In addition to applicability in memory systems as described herein, techniques for compression-based address mapping management in a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by increasing a size of the L2P table that is storable in the local memory, which may increase a likelihood that the mapping of a logical address is already stored in the local memory 120 (e.g., increases a likelihood of a cache hit condition occurring increases). Such conditions may decrease processing or latency times, improve response times, or otherwise improve user experience, among other benefits.

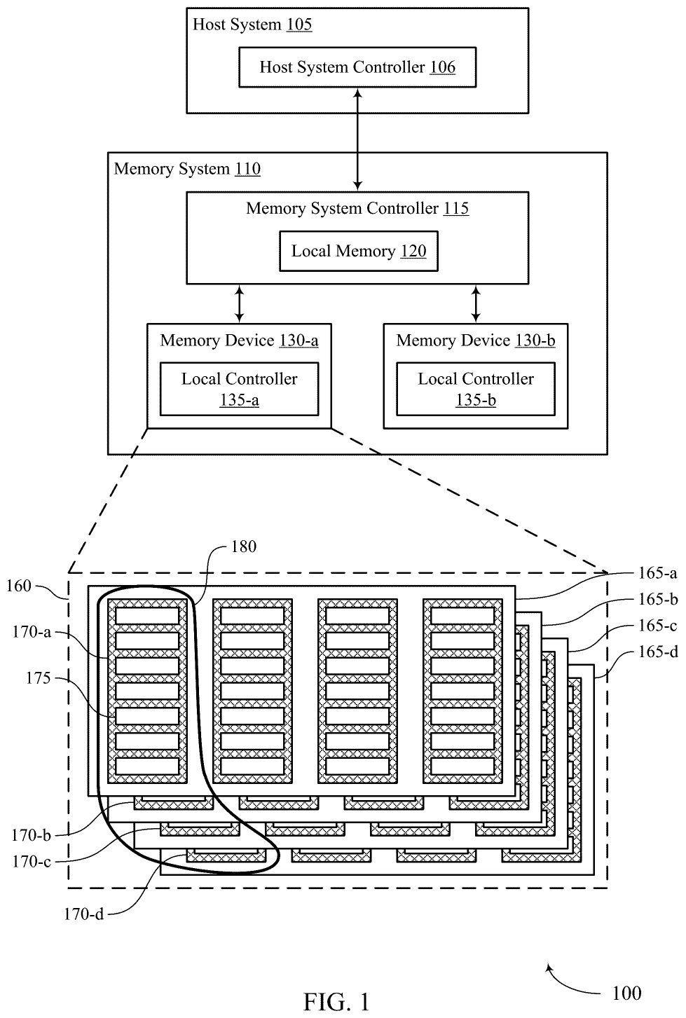

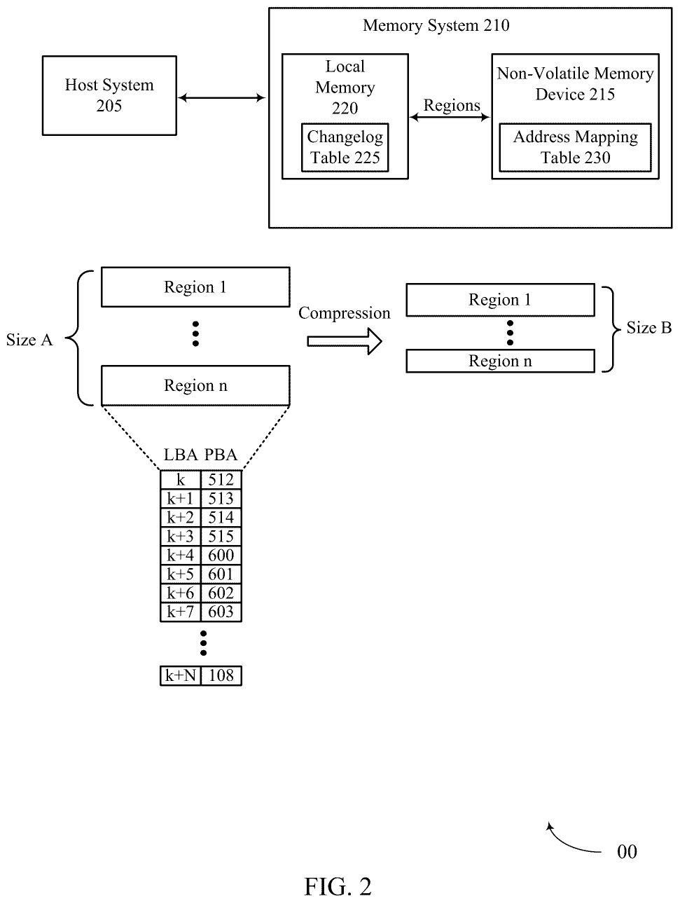

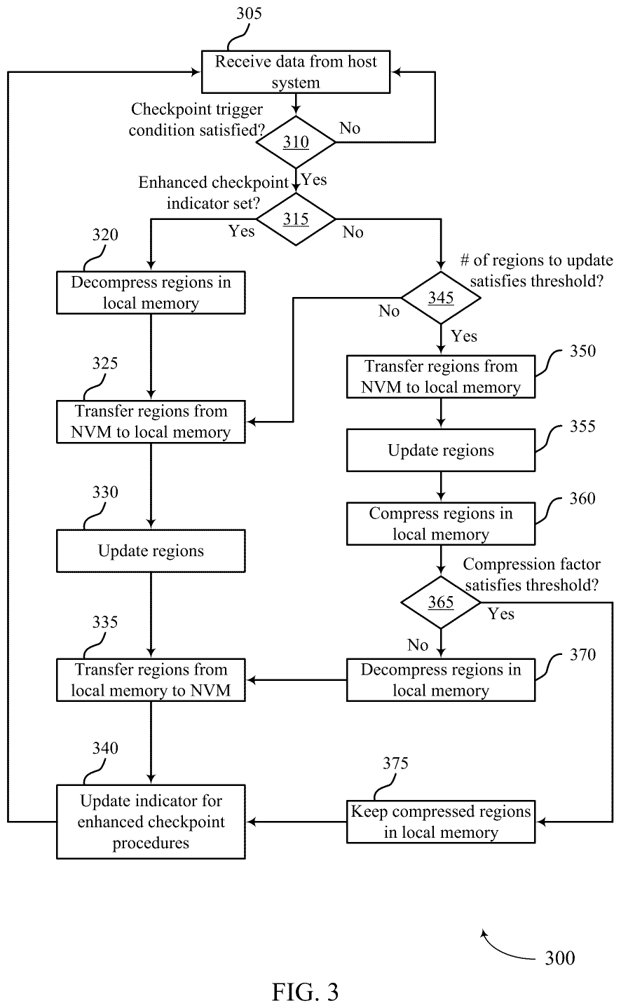

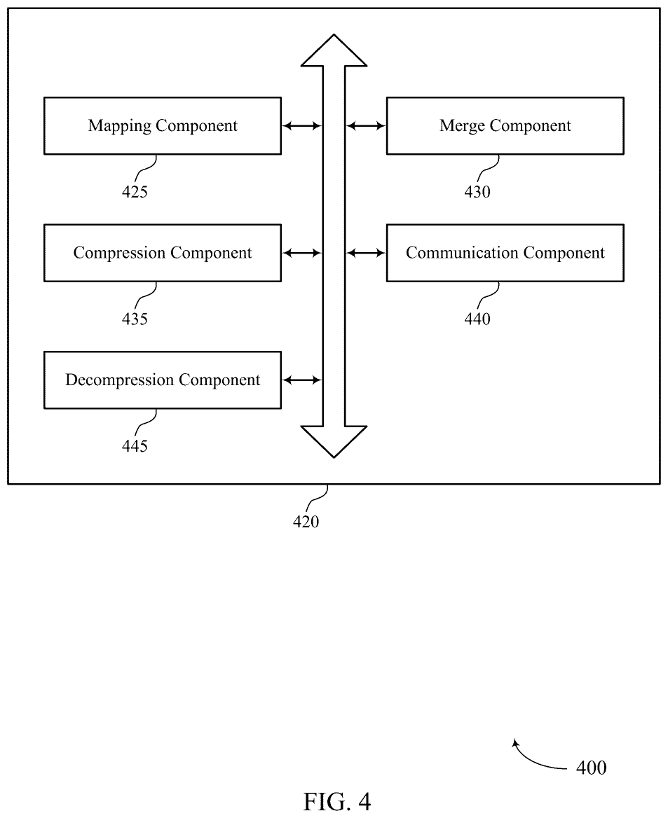

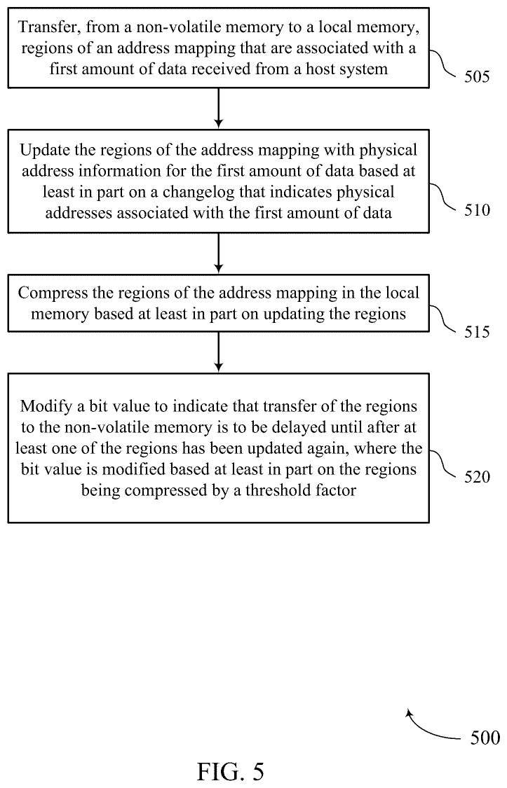

Features of the disclosure are initially described in the context of systems, devices, and circuits with reference to FIGS. 1 through 2. Features of the disclosure are described in the context of process flow with reference to FIG. 3. These and other features of the disclosure are further illustrated by and described in the context of an apparatus diagram and flowchart that relate to compression-based address mapping management in a memory system with reference to FIGS. 4 and 5.

FIG. 1 shows an example of a system 100 that supports compression-based address mapping management in a memory system in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses (PBAs)) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support compression-based address mapping management in a memory system. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

The memory system 110 may use an address mapping, such as an L2P table, to perform address translation between logical addresses and physical addresses. To ensure preservation of the address mapping (e.g., in the event of power-loss), the memory system 110 may store the address mapping in a non-volatile memory, such as one or more of the memory devices 130. To update or use the address mapping, the memory system 110 may transfer regions of the address mapping from the non-volatile memory to the local memory 120, which may be a volatile memory of insufficient size to hold the entire address mapping.

The address information used to update the address mapping may be maintained in a changelog and the memory system 110 may initiate a checkpoint procedure to update address mapping if the size of the changelog has reached a threshold size. For instance, the memory system 110 may initiate a checkpoint procedure upon determining that the changelog is x kB, which may correspond to the memory system 110 receiving a threshold amount of data from the host system 105. In other examples, the memory system may initiate a checkpoint procedure upon determining that an amount of data received from the host system 105 (e.g., for writing) satisfies a threshold amount.

During a checkpoint procedure, the memory system 110 may retrieve (from the non-volatile memory) regions of the address mapping that are associated with the data received from the host system. For example, if the data received from the host system is associated with a set of logical addresses, the memory system 110 may retrieve the regions of the address mapping that are associated with logical addresses in the set of logical addresses. In a sequential write, the set of logical addresses may be consecutively indexed logical addresses. In a random write, the set of logical addresses may be non-consecutively indexed. If the address mapping is organized according to consecutively indexed logical addresses, the quantity of regions retrieved for sequential writes may be greater than the quantity of regions retrieved for random writes. After retrieving the regions of the address mapping and writing the regions to the local memory 120, the memory system 110 may use the changelog to update the regions. Updating the regions may include updating the physical addresses mapped to the logical addresses (e.g., updating the entry for logical address x to indicate that logical address x is mapped to physical address y).

At the conclusion of the checkpoint procedure (e.g., after updating the regions), the memory system 110 may transfer (e.g., flush) the regions back to the non-volatile memory. But flushing regions at the conclusion of each checkpoint procedure may increase the latency of the memory system 110 (e.g., because writing the regions to the non-volatile memory may interfere with other memory access operations for the non-volatile memory). Flushing regions at the conclusion of each checkpoint procedure may also increase the quantity of times a given region is retrieved from the non-volatile memory, which may increase the overhead and latency associated with address translation.

According to the techniques described herein, the memory system 110 may selectively refrain from flushing regions of the address mapping to the non-volatile memory at the conclusion of checkpoint procedures. For example, after performing a first checkpoint procedure, the memory system 110 may delay flushing the regions associated with the first checkpoint procedure until conclusion of a second (e.g., subsequent) checkpoint procedure. A condition for delaying flushing may be that the regions associated with the first checkpoint are compressible (or have been compressed) by a threshold amount given by a compression factor.

FIG. 2 shows an example of a system 200 that supports compression-based address mapping management in a memory system in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively. The memory system 210 may include a local memory 220, which may be an example of the local memory 120 described with reference to FIG. 1, and a non-volatile memory device 215, which may be an example of one or more memory devices 130 as described with reference to FIG. 1.

The memory system 210 may receive write commands and associated data and logical addresses from the host system 205. For example, the memory system 210 may receive write commands for a set of data that is associated with a set of logical addresses that are in turn associated with a set of regions of an address mapping table 230 stored by the non-volatile memory device 215. An address mapping table may also be referred to as an address mapping, as address mapping information, or other suitable terminology. A region of an address mapping table may refer to a set of entries with address mapping information for mapping logical addresses to physical addresses. A region of an address mapping table may also be referred to as a portion of the address mapping table, a subset of the address mapping table, or other suitable terminology. In some cases, a region of the address mapping table may be a portion of the address mapping table that is transferred between a non-volatile memory device and a local memory.

The address mapping table 230 may be divided into regions that provide mapping information for different ranges of logical addresses. For example, a region n may provide mapping information for N+1 sequentially indexed logical addresses, such as logical address k through logical address k+N. Each entry of the region may indicate the mapping (e.g., correspondence) between the logical address for that entry and a physical address. For instance, region n may indicate that logical address k is mapped to physical address n. Although each entry is shown with an associated logical address and physical address pair, in some examples, only the physical addresses may be included in a region (e.g., the logical addresses may be implicitly associated with the entries but not necessarily stored in the address mapping table 230).

Upon determining that a trigger condition for initiating a checkpoint procedure has been satisfied, the memory system 210 may transfer the regions of the address mapping table 230 from the non-volatile memory device 215 to the local memory 220 for updating. In some examples, the trigger condition may be the size of the changelog table 225 satisfying a threshold size. A changelog table 225 may refer to a set of entries that indicate mapping information for mapping logical addresses to physical addresses. As commands are received from the host system 205, the memory system 210 may store changes for the address mapping table 230 in the changelog table 225 temporarily. Such techniques may enable the memory system 210 to batch updates to the address mapping table 230 and improve efficiency for updating the address mapping table 230. As discussed, the changelog table 225 may be stored in the local memory 220 and may track the physical addresses assigned to the logical addresses as data associated with the logical addresses is written to (or designated for) the non-volatile memory device 215. So, changes in the mapping information for a set of logical addresses may be accumulated in the changelog table 225 and used to update address mapping table regions during checkpoint procedures.

The regions transferred to the local memory 220 for the checkpoint procedure may be associated with the data received from the host system 205 (and thus associated with the logical addresses in the changelog table). For example, if the data received from the host system 205 is associated with a set of regions including region 1 through region n, the memory system 210 may transfer the set of regions from the non-volatile memory device 215 to the local memory 220. After transferring the set of regions to the local memory 220, the memory system 210 may update the set of regions using the changelog table 225. For example, the memory system 210 may “merge” the changelog table 225 with the set of regions by updating the entries of the regions to indicate the physical addresses mapped to the associated logical addresses (as indicated by the changelog table 225). In some cases, the local memory 220 may include a merge buffer to update the regions of the address mapping table 230 using the entries in the changelog table 225. Once an entry of the changelog table 225 is used to update the address mapping table 230, that entry is removed from the changelog table 225.

After updating the set of regions, the memory system 210 may compress the set of regions currently stored in the local memory 220. In some examples, the memory system 210 may compress the set of regions if a compression condition is satisfied. For example, the memory system 210 may compress the set of regions if the quantity of regions in the set of regions satisfies a threshold quantity. For example, if the compression scheme of the address mapping table 230 will compress the information to be less than half the size of the uncompressed information, the memory system 210 may implement the compression. Any threshold quantity of compression may be used by the memory system 210 to determine whether it is worth compressing and retaining in the local memory 220.

Compressing a region may include modifying the region so that the information in the region is a smaller size (e.g., occupies less memory space). In some examples, the memory system 210 may compress a region by removing some of the entries for a set of logical addresses that are mapped to sequentially indexed physical addresses (in which case the memory system 210 may add an index of offset that indicates how many entries have been removed). For instance, the memory system 210 may compress region n by removing the entries for physical address 513 through physical address 515 and removing the entries for physical address 601 through 603. Such information may be replaced with an indication that a quantity of addresses are sequentially mapped (e.g., sequential logical addresses are mapped to sequential physical addresses).

The amount of compression applied to a region (e.g., the size reduction) may be referred to as the compression factor for that region and the collective amount of compression applied to a set of regions (which may be an average of the region-specific compression factors) may be referred to as the compression factor for the set of regions. To illustrate, if the size of region n is halved (e.g., region n goes from y kB to y/2 kB), the compression factor may be two. The compression factors for different regions may be the same or different. For example, the compression factor for region 1 may be 1.3 and the compression factor for region n may be 2. Similarly, the compression factor for a region may be different than the compression factor for the set of regions that includes the region. For example, the compression factor for region 1 may be 1.3 and the compression factor for the set of regions may three. Thus, the size of the set of regions may be size A before compression and may be size B after compression, where size B is less than size A.

After compressing the set of regions, the memory system 210 may determine whether to maintain the set of regions in the local memory 220 until the next checkpoint or to flush the set of regions back to the non-volatile memory device 215. The memory system 210 may maintain the set of regions in the local memory 220 until the next checkpoint if the memory system 210 determines that the compression factor satisfies (e.g., is greater than or equal to) a threshold (which may be selected to ensure that there is sufficient room in the local memory 220 for regions associated with the next checkpoint). Thus, the memory system 210 may delay transfer of the set of regions until the next checkpoint (e.g., until at least one region is updated again), which may reduce the quantity of times regions are transferred between the local memory 220 and the non-volatile memory device 215. If the compression factor does not satisfy the threshold, the memory system 210 may decompress the set of regions and flush (e.g., transfer) the set of regions back to the non-volatile memory device 215.

In some examples, the memory system 210 may refrain from compressing the set of regions unless the memory system 210 predicts that the compression factor for the set of regions is likely to satisfy the threshold. Such a technique may allow the memory system 210 to avoid unnecessarily compressing the set of regions only to decompress the set of regions upon determining (after compressing the set of regions) that the compression factor does not satisfy the threshold.

If a set of regions is maintained in the local memory 220 in between a first checkpoint procedure and a second checkpoint procedure that involves a second set of regions, the memory system 210 may refrain from compressing (or maintaining in the local memory 220) the second set of regions. Put another way, if a checkpoint procedure that involves compression and maintenance of regions in the local memory 220 is referred to as an enhanced checkpoint procedure, the memory system 210 may avoid performing multiple enhanced checkpoint procedures back-to-back. To do so, the memory system 210 may use an indicator (e.g., a bit, a mode register bit) to track enhanced checkpoint procedures (e.g., to indicate that a set of regions has been maintained in the local memory 220 between checkpoint procedures). For example, the memory system 210 may set the indicator to a first value to indicate that a set of regions has been maintained in the local memory 220 between checkpoint procedures and may set the indicator to a second value after flushing the set of regions to the non-volatile memory device 215. In some examples the indicator may be referred to as an enhanced checkpoint bit. In some cases, the indicator may be a plurality of bits and may indicate more information. In such examples, compressed regions of the address mapping table 230 may be stored in the local memory 220 for more than one check point procedure. For example, if the indicator is two bits, the compressed regions of the address mapping table 230 may be enabled to remain in the local memory 220 for up to four checkpoint procedure. The indicator may be any quantity of bits (e.g., one, two, three, four, five, six, seven, eight).

The compressed set of regions may be retained in the local memory 220 until the conclusion of a second checkpoint procedure, at which point the set of regions may be flushed to the non-volatile memory device 215 (along with a second set of regions associated with the second checkpoint procedure). In some examples, the second set of regions may include one or more regions from the set of regions (referred to as shared regions) associated with the enhanced checkpoint procedure. In such examples, the memory system 210 may refrain from transferring the shared regions from the non-volatile memory device 215 to the local memory 220 for the second checkpoint procedure (e.g., because the shared regions are already in the local memory 220 and the versions in the non-volatile memory device 215 are outdated). Instead, the memory system 210 may update (e.g., after decompression) the shared regions that are already in the local memory 220. After updating the second set of regions associated with the second checkpoint procedure (which may include shared regions that are associated with the enhanced checkpoint procedure) the memory system 210 may decompress (as applicable) the regions in the local memory 220 and transfer the regions to the non-volatile memory device 215.

Thus, the memory system 210 may implement an enhanced checkpoint procedure in which regions of an address mapping table are compressed and maintained in the local memory 220 in between the enhanced checkpoint procedure and a second subsequent checkpoint procedure.

FIG. 3 shows an example of a process flow 300 that supports compression-based address mapping management in a memory system in accordance with examples as disclosed herein. The process flow 300 may be implemented by a memory system such as the memory system 110 or the memory system 210 as described with reference to FIGS. 1 and 2, respectively. The process flow 300 may illustrate operations of a memory system that implements an enhanced checkpoint procedure as described herein.

Aspects of the process flow 300 may be implemented by a controller, among other components. Additionally or alternatively, aspects of the process flow 300 may be implemented as instructions stored in memory (e.g., firmware stored in a memory coupled with a memory system). For example, the instructions, if executed by a controller (e.g., the memory system controller 115, a local controller 135), may cause the controller to perform the operations of the process flow 300.

At 305, data may be received. For example, the data may be received by the memory system (e.g., the memory system 210) from the host system (e.g., the host system 205) and may be associated with an access command (e.g., a write command, read command). The data may be a first amount of data and may be associated with a first set of logical addresses. For example, if write commands are received, the memory system may also receive logical addresses associated with the data to store in the memory system. The memory system may then store the data in the non-volatile memory device at a physical address of the non-volatile memory device of the memory system. The memory system may then create an entry in the changelog table indicating the relationship between the logical address receive as part of the write command the physical address that stores the data.

At 310, it may be determined (e.g., by the memory system 210) that a condition for triggering a checkpoint procedure has been satisfied. In some examples, the memory system 210 may determine that the condition has been satisfied by determining that the size of the changelog table 225 satisfies (e.g., is greater than or equal to) a threshold size. Said another way, the address mapping table 230 may be updated based on the changelog table 225 becoming full or nearly full. In some examples, the memory system 210 may determine that the condition has been satisfied by determining that the first amount of data satisfies (e.g., is greater than or equal to) a threshold amount. If the threshold has not been satisfied, the memory system may continue to receive data (e.g., at 305). If the threshold has been satisfied, the memory system may initiate a checkpoint procedure and move to 310.

At 315, it may be determined (e.g., by the memory system 210) whether the enhanced checkpoint indicator indicates whether the previous checkpoint procedure (e.g., the immediately preceding the current checkpoint procedure) was an enhanced checkpoint procedure. If indicator is set (e.g., the last checkpoint was enhanced), then compressed regions of the address mapping table 230 are still stored in the local memory 220. If the indicator is not set, the memory system may determine whether this checkpoint procedure is to include compressing regions of the address mapping table 230 and keeping those compressed portions in the local memory 220. If, at 315, it is determined that the enhanced checkpoint indicator has a first value (e.g., is set), the memory system 210 may proceed to 320 and the associated procedures. If, at 315, it is determined that the enhanced checkpoint indicator has a second value (e.g., is not set), the memory system 210 may proceed to 345 and its associated procedures.

At 320, regions of the address mapping table 230 that are stored in local memory 220 may be decompressed based on the enhanced checkpoint indictor being set. If the enhanced checkpoint indictor is set it indicates that the regions of the address mapping table 230 that are stored in local memory 220 are to be transferred to the non-volatile memory device 215 and that compression is not to be attempted. Before such information is transferred, the memory system 210 may update the relevant regions of the address mapping table 230 associated with the checkpoint procedure. For example, the entries in the changelog table 225 may be used to update the address mapping table 230. Decompressing the regions of the address mapping table 230 stored in the local memory 220 may be useful to facilitate the updating of the address mapping table 230.

At 325, a set of regions of an address mapping table 230 (e.g., an L2P table) may be transferred (e.g., retrieved, fetched) from a non-volatile memory device 215 of the memory system 210 and loaded (e.g., written) into a local memory 220 of the memory system 210. In some cases, this step may not be performed. For example, if all of the regions that the changelog table 225 indicates that are to be updated are already stored in the local memory 220. In some cases, the transferring of regions from the non-volatile memory device 215 to the local memory 220 may be performed before the functions of 320, at least partially overlapping with performing the functions of 320, after the functions of 320, before the functions of 330, at least partially overlapping with performing the functions of 330, or any combination thereof. The regions that are transferred may be examples of regions that the changelog table 225 indicates that are to be updated as part of the checkpoint procedure.

At 330, the set of regions of the address mapping table 230 may be updated. For example, the memory system 210 may update the set of regions with physical address information from the entries of the changelog table 225. The updates may include associating logical addresses in the address mapping table 230 with physical addresses indicated in the changelog table 225. Physical address information may refer to information that indicates one or more physical addresses of the non-volatile memory device 215 of the memory system 210.

At 335, the regions of the address mapping table 230 stored in the local memory 220 may be transferred from the local memory 220 to the non-volatile memory device 215. Transferring the address mapping table 230 may protect the address mapping table 230 from losing data in the event of an asynchronous power loss. For example, if an asynchronous power loss occurs, the information stored in the local memory 220 may be lost, but the information stored in the non-volatile memory device 215 may be maintained.

At 340, the enhanced checkpoint indicator may be updated. In the case that regions of the address mapping table 230 are transferred to the non-volatile memory device 215, the indicator is updated to a second value associated with indicating that compression may be attempted on the next checkpoint procedure. In the case that region of the address mapping table 230 are compressed and stored in the local memory 220, the indicator is updated to a first value associated with indicating that compression is not to be attempted on the next checkpoint procedure.

In the foregoing description, the enhanced checkpoint indicator is a binary indicator. In some cases, the enhanced checkpoint indicator may be configured to indicate more information than two states. In such cases, the memory system 210 may be configured to attempt compression of the address mapping table 230 on multiple consecutive checkpoint procedures before transferring (e.g., flushing) the address mapping table 230 stored in the local memory 220 to the non-volatile memory device 215. In such cases, a single state of the enhanced checkpoint indicator may indicate that that compression is not to be attempted on the next checkpoint procedure and a plurality of states of the enhanced checkpoint indicator may indicate that compression may be attempted on the next checkpoint procedure.

In cases where, at 315, it is determined that the enhanced checkpoint indicator has a second value (e.g., is not set), the memory system 210 may proceed to 345 and its associated procedures. In such cases, the enhanced checkpoint indicator is indicating that the local memory 220 does not include a compressed version of the address mapping table 230 and that regions of the address mapping table 230 are to be transferred from the non-volatile memory device 215.

At 345, it may be determined whether a quantity of regions of the address mapping table 230 satisfy a threshold. The quantity of regions that are updated may be used to approximate the range of address spaces that are being updated. If the range of address space being updated is relatively small (e.g., does not satisfy the threshold), the cost (e.g., latency, power consumption, processing time) of compressing the address mapping table 230 may exceed the benefits realized on subsequent checkpoint procedures. In such cases, the memory system 210 may not attempt compression and may proceed with a non-compression-based checkpoint procedure. In such cases, the memory system 210 may proceed to 325, 330, 335, and 340 to complete the checkpoint procedure. If, however, it is determined that the regions of the address mapping table 230 satisfy the threshold, the memory system 210 may proceed to 350 and attempt compression of the regions of the address mapping table 230.

At 350, a set of regions of an address mapping table 230 (e.g., an L2P table) may be transferred (e.g., retrieved, fetched) from a non-volatile memory device 215 of the memory system 210 and loaded (e.g., written) into a local memory 220 of the memory system 210. In some cases, the transferring of regions from the non-volatile memory device 215 to the local memory 220 may be performed before the functions of 355, at least partially overlapping with performing the functions of 355, after the functions of 355, or any combination thereof. The regions that are transferred may be examples of regions that the changelog table 225 indicates that are to be updated as part of the checkpoint procedure.

At 355, the set of regions of the address mapping table 230 may be updated. For example, the memory system 210 may update the set of regions with physical address information from the entries of the changelog table 225. The updates may include associating logical addresses in the address mapping table 230 with physical addresses indicated in the changelog table 225. Physical address information may refer to information that indicates one or more physical addresses of the non-volatile memory device 215 of the memory system 210.

At 360, the regions of the address mapping table 230 may be compressed (e.g., by the memory system 210). For example, the first set of regions may be compressed from a first size to a second size according to a compression factor. The first set of regions may be compressed based on the enhanced checkpoint indicator indicating that the previous checkpoint procedure was an unenhanced checkpoint procedure or that the enhanced checkpoint indicator indicating that a subsequent checkpoint can continue with compression. Compressing a region may include modifying the region so that the information in the region is a smaller size (e.g., occupies less memory space). In some examples, the memory system 210 may compress a region by removing some of the entries for sequentially indexed logical addresses that are mapped to sequentially indexed physical addresses. In response to sequentially indexed logical addresses being mapped to sequentially indexed physical addresses, some of the entries in the address mapping table 230 may be replaced with an indicator of the starting logical address of the sequentially indexed set, the starting physical address of the sequentially indexed set, and the length of the sequentially indexed set. In this manner logical-to-physical address mappings may be stored in the local memory 220 using less memory without losing information related to the mappings. Such a compression, however, may make it challenging to update such mappings. Thus, in some cases, if the mapping is to be updated, it may be decompressed first. Other examples of compression are also possible. In other examples, the memory system 210 may compress region n by removing the entries for physical address 513 through physical address 515 and removing the entries for physical address 601 through 603. Such information may be replaced with an indication that a quantity of addresses are sequentially mapped (e.g., sequential logical addresses are mapped to sequential physical addresses).

At 365, it may be determined whether the compression factor of the compression of the address mapping table satisfies a threshold. If the compression factor fails to satisfy the threshold, the address mapping may be decompressed (at 370) and the regions transferred to the non-volatile memory device 215 (at 335). In such cases, the cost of compressing and storing the data in the local memory 220 may not justify the benefits for faster recall on the next checkpoint procedure. If, however, the compression factor does satisfy the threshold, the memory system 210 may proceed to 375 and keep the compressed regions of the address mapping table 230 stored in the local memory 220 until after the next checkpoint procedure. After determining to keep the compress regions in the local memory 220, the memory system 210 may update the enhanced checkpoint indicator at 340 and continue with the process. In some examples, the threshold for the compression factor is two (2). In such examples, unless the regions of the address mapping table 230 are compressed to be equal to or less than 50% of the size of the original information, the memory system 210 may flush the address mapping table 230 from the local memory 220 to the non-volatile memory device 215. Example of the compression threshold may include compression factors of 1.1, 1.2, 1.3, 1.4,1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5,3.6, 3.7, 3.8, 3.9, 4.0, 4.1, 4.2, 4.3, 4.4, 4.5, 4.6, 4.7, 4.8, 4.9, 5.0, 5.5, 6.0, 6.5, 7.0, 7.5, and 8.0.

At 375, the compressed regions may be stored in the local memory 220 for use by the next checkpoint procedure. In some examples, the compressed regions of the address mapping table 230 may be stored in a merge buffer of the local memory 220. The merge buffer may be a portion of the local memory dedicated to updating regions of the address mapping table 230 using the changelog table 225 as part of a checkpoint procedure.

In some alternative examples, it may be predicted whether a compression factor of the regions of the address mapping table 230 stored in the local memory 220 are compressible to a compression factor that satisfies a threshold. In such cases, instead of compressing regions (at 360) and then comparing the compression factor of the compressed regions with a threshold, the memory system 210 may perform processing to predict whether the compression factor will likely satisfy the threshold. If the predicted value will satisfy the threshold, the memory system 210 may proceed with compression. However, if the predicted value will fail to satisfy the threshold, the memory system 210 may proceed to transfer the regions from the local memory 220 to the non-volatile memory device 215 without compressing the data (e.g., at 335).

Such compression techniques may be configured to reduce the quantity of transfers of the address mapping table 230 between the non-volatile memory device 215 and the local memory 220, which may improve latency and power consumption, among other benefits. Additionally, such techniques may improve the latency for access operations over a broader range of addressing space (e.g., over a broader range of host data being accessed). Alternative examples of the foregoing may be implemented, where some operations are performed in a different order than described, are performed in parallel, or are not performed at all. In some cases, operations may include additional features not mentioned herein, or further operations may be added. Additionally, certain operations may be performed multiple times or certain combinations of operations may repeat or cycle.

FIG. 4 shows a block diagram 400 of a memory system 420 that supports compression-based address mapping management in a memory system in accordance with examples as disclosed herein. The memory system 420 may be an example of aspects of a memory system as described with reference to FIGS. 1 through 3. The memory system 420, or various components thereof, may be an example of means for performing various aspects of compression-based address mapping management in a memory system as described herein. For example, the memory system 420 may include a mapping component 425, a merge component 430, a compression component 435, a communication component 440, a decompression component 445, or any combination thereof. Each of these components may communicate, directly or indirectly, with one another (e.g., via one or more buses).

The mapping component 425 may be configured as or otherwise support a means for transferring, from a non-volatile memory to a local memory, regions of an address mapping that are associated with a first amount of data received from a host system. The merge component 430 may be configured as or otherwise support a means for updating the regions of the address mapping with physical address information for the first amount of data based at least in part on a changelog that indicates physical addresses associated with the first amount of data. The compression component 435 may be configured as or otherwise support a means for compressing the regions of the address mapping in the local memory based at least in part on updating the regions. In some examples, the mapping component 425 may be configured as or otherwise support a means for modifying a bit value to indicate that transfer of the regions to the non-volatile memory is to be delayed until after at least one of the regions has been updated again, where the bit value is modified based at least in part on the regions being compressed by a threshold factor.

In some examples, the compression component 435 may be configured as or otherwise support a means for determining that the regions transferred to the local memory include more than a threshold quantity of regions, where the regions are compressed based at least in part on the regions including more than the threshold quantity of regions.

In some examples, the communication component 440 may be configured as or otherwise support a means for receiving a second amount of data from the host system. In some examples, the merge component 430 may be configured as or otherwise support a means for updating one or more regions of the regions based at least in part on the second amount of data.

In some examples, the communication component 440 may be configured as or otherwise support a means for transferring the regions to the non-volatile memory based at least in part on updating the one or more regions.

In some examples, the decompression component 445 may be configured as or otherwise support a means for decompressing the regions in the local memory, where the regions are transferred to the non-volatile memory based at least in part on decompressing the regions.

In some examples, the decompression component 445 may be configured as or otherwise support a means for decompressing the one or more regions based at least in part on the one or more regions being associated with the second amount of data, where the one or more regions are updated based at least in part on decompressing the one or more regions.

In some examples, the communication component 440 may be configured as or otherwise support a means for transferring, from the non-volatile memory to the local memory, additional regions of the address mapping that are associated with the second amount of data, where the regions are transferred to the non-volatile memory after transferring the additional regions to the local memory.

In some examples, the communication component 440 may be configured as or otherwise support a means for determining that a condition for transferring the additional regions has been satisfied, where the regions are transferred based at least in part on determining that the condition has been satisfied.

In some examples, the communication component 440 may be configured as or otherwise support a means for determining that the first amount of data satisfies a threshold amount, where the regions are transferred based at least in part on determining that the first amount of data satisfies the threshold amount.

In some examples, the compression component 435 may be configured as or otherwise support a means for determining that a size of the changelog satisfies a threshold size, where the regions are transferred based at least in part on determining that the size of the changelog satisfies the threshold size.

In some examples, the bit value includes a flag that indicates whether the regions of the address mapping are compressed.

FIG. 5 shows a flowchart illustrating a method 500 that supports compression-based address mapping management in a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the wireless memory system may perform aspects of the described functions using special-purpose hardware.

At 505, the method may include transferring, from a non-volatile memory to a local memory, regions of an address mapping that are associated with a first amount of data received from a host system. The operations of 505 may be performed in accordance with examples as disclosed herein. In some examples, aspects of the operations of 505 may be performed by a mapping component 425 as described with reference to FIG. 4.

At 510, the method may include updating the regions of the address mapping with physical address information for the first amount of data based at least in part on a changelog that indicates physical addresses associated with the first amount of data. The operations of 510 may be performed in accordance with examples as disclosed herein. In some examples, aspects of the operations of 510 may be performed by a merge component 430 as described with reference to FIG. 4.

At 515, the method may include compressing the regions of the address mapping in the local memory based at least in part on updating the regions. The operations of 515 may be performed in accordance with examples as disclosed herein. In some examples, aspects of the operations of 515 may be performed by a compression component 435 as described with reference to FIG. 4.

At 520, the method may include modifying a bit value to indicate that transfer of the regions to the non-volatile memory is to be delayed until after at least one of the regions has been updated again, where the bit value is modified based at least in part on the regions being compressed by a threshold factor. The operations of 520 may be performed in accordance with examples as disclosed herein. In some examples, aspects of the operations of 520 may be performed by a mapping component 425 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for transferring, from a non-volatile memory to a local memory, regions of an address mapping that are associated with a first amount of data received from a host system; updating the regions of the address mapping with physical address information for the first amount of data based at least in part on a changelog that indicates physical addresses associated with the first amount of data; compressing the regions of the address mapping in the local memory based at least in part on updating the regions; and modifying a bit value to indicate that transfer of the regions to the non-volatile memory is to be delayed until after at least one of the regions has been updated again, where the bit value is modified based at least in part on the regions being compressed by a threshold factor.
Aspect 2: The method, apparatus, or non-transitory computer-readable medium of aspect 1, further including operations, features, circuitry, logic, means, or instructions, or any combination thereof for determining that the regions transferred to the local memory include more than a threshold quantity of regions, where the regions are compressed based at least in part on the regions including more than the threshold quantity of regions.
Aspect 3: The method, apparatus, or non-transitory computer-readable medium of any of aspects 1 through 2, further including operations, features, circuitry, logic, means, or instructions, or any combination thereof for receiving a second amount of data from the host system and updating one or more regions of the regions based at least in part on the second amount of data.
Aspect 4: The method, apparatus, or non-transitory computer-readable medium of aspect 3, further including operations, features, circuitry, logic, means, or instructions, or any combination thereof for transferring the regions to the non-volatile memory based at least in part on updating the one or more regions.
Aspect 5: The method, apparatus, or non-transitory computer-readable medium of any of aspects 3 through 4, further including operations, features, circuitry, logic, means, or instructions, or any combination thereof for decompressing the regions in the local memory, where the regions are transferred to the non-volatile memory based at least in part on decompressing the regions.
Aspect 6: The method, apparatus, or non-transitory computer-readable medium of any of aspects 3 through 5, further including operations, features, circuitry, logic, means, or instructions, or any combination thereof for decompressing the one or more regions based at least in part on the one or more regions being associated with the second amount of data, where the one or more regions are updated based at least in part on decompressing the one or more regions.
Aspect 7: The method, apparatus, or non-transitory computer-readable medium of any of aspects 3 through 6, further including operations, features, circuitry, logic, means, or instructions, or any combination thereof for transferring, from the non-volatile memory to the local memory, additional regions of the address mapping that are associated with the second amount of data, where the regions are transferred to the non-volatile memory after transferring the additional regions to the local memory.
Aspect 8: The method, apparatus, or non-transitory computer-readable medium of aspect 7, further including operations, features, circuitry, logic, means, or instructions, or any combination thereof for determining that a condition for transferring the additional regions has been satisfied, where the regions are transferred based at least in part on determining that the condition has been satisfied.
Aspect 9: The method, apparatus, or non-transitory computer-readable medium of any of aspects 1 through 8, further including operations, features, circuitry, logic, means, or instructions, or any combination thereof for determining that the first amount of data satisfies a threshold amount, where the regions are transferred based at least in part on determining that the first amount of data satisfies the threshold amount.
Aspect 10: The method, apparatus, or non-transitory computer-readable medium of any of aspects 1 through 9, further including operations, features, circuitry, logic, means, or instructions, or any combination thereof for determining that a size of the changelog satisfies a threshold size, where the regions are transferred based at least in part on determining that the size of the changelog satisfies the threshold size.
Aspect 11: The method, apparatus, or non-transitory computer-readable medium of any of aspects 1 through 10, where the bit value includes a flag that indicates whether the regions of the address mapping are compressed.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily doped, e.g., degenerate, semiconductor region. The source and drain may be separated by a lightly doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a controller associated with a memory device, wherein the controller is configured to cause the apparatus to:
transfer, from a non-volatile memory to a local memory, regions of an address mapping that are associated with a first amount of data received from a host system;
update the regions of the address mapping with physical address information for the first amount of data based at least in part on a changelog that indicates physical addresses associated with the first amount of data;
compress the regions of the address mapping in the local memory based at least in part on updating the regions; and
modify a bit value to indicate that transfer of the regions to the non-volatile memory is to be delayed until after at least one of the regions has been updated again, wherein the bit value is modified based at least in part on the regions being compressed by a threshold factor.

2. The apparatus of claim 1, wherein the controller is further configured to cause the apparatus to:
determine that the regions transferred to the local memory include more than a threshold quantity of regions, wherein the regions are compressed based at least in part on the regions including more than the threshold quantity of regions.

3. The apparatus of claim 1, wherein the controller is further configured to cause the apparatus to:
receive a second amount of data from the host system; and
update one or more regions of the regions based at least in part on the second amount of data.

4. The apparatus of claim 3, wherein the controller is further configured to cause the apparatus to:
transfer the regions to the non-volatile memory based at least in part on updating the one or more regions.

5. The apparatus of claim 3, wherein the controller is further configured to cause the apparatus to:
decompress the regions in the local memory, wherein the regions are transferred to the non-volatile memory based at least in part on decompressing the regions.

6. The apparatus of claim 3, wherein the controller is further configured to cause the apparatus to:
decompress the one or more regions based at least in part on the one or more regions being associated with the second amount of data, wherein the one or more regions are updated based at least in part on decompressing the one or more regions.

7. The apparatus of claim 3, wherein the controller is further configured to cause the apparatus to:
transfer, from the non-volatile memory to the local memory, additional regions of the address mapping that are associated with the second amount of data, wherein the regions are transferred to the non-volatile memory after transferring the additional regions to the local memory.

8. The apparatus of claim 7, wherein the controller is further configured to cause the apparatus to:
determine that a condition for transferring the additional regions has been satisfied, wherein the regions are transferred based at least in part on determining that the condition has been satisfied.

9. The apparatus of claim 1, wherein the controller is further configured to cause the apparatus to:
determine that the first amount of data satisfies a threshold amount, wherein the regions are transferred based at least in part on determining that the first amount of data satisfies the threshold amount.

10. The apparatus of claim 1, wherein the controller is further configured to cause the apparatus to:
determine that a size of the changelog satisfies a threshold size, wherein the regions are transferred based at least in part on determining that the size of the changelog satisfies the threshold size.

11. The apparatus of claim 1, wherein the bit value comprises a flag that indicates whether the regions of the address mapping are compressed.

12. A non-transitory computer-readable medium storing code, the code comprising instructions executable by a processor to:
transfer, from a non-volatile memory to a local memory, regions of an address mapping that are associated with a first amount of data received from a host system;
update the regions of the address mapping with physical address information for the first amount of data based at least in part on a changelog that indicates physical addresses associated with the first amount of data;
compress the regions of the address mapping in the local memory based at least in part on updating the regions; and
modify a bit value to indicate that transfer of the regions to the non-volatile memory is to be delayed until after at least one of the regions has been updated again, wherein the bit value is modified based at least in part on the regions being compressed by a threshold factor.

13. The non-transitory computer-readable medium of claim 12, wherein the instructions are further executable by the processor to:
determine that the regions transferred to the local memory include more than a threshold quantity of regions, wherein the regions are compressed based at least in part on the regions including more than the threshold quantity of regions.

14. The non-transitory computer-readable medium of claim 12, wherein the instructions are further executable by the processor to:
receive a second amount of data from the host system; and
update one or more regions of the regions based at least in part on the second amount of data.

15. The non-transitory computer-readable medium of claim 14, wherein the instructions are further executable by the processor to:
transfer the regions to the non-volatile memory based at least in part on updating the one or more regions.

16. The non-transitory computer-readable medium of claim 14, wherein the instructions are further executable by the processor to:
decompress the regions in the local memory, wherein the regions are transferred to the non-volatile memory based at least in part on decompressing the regions.

17. The non-transitory computer-readable medium of claim 14, wherein the instructions are further executable by the processor to:
decompress the one or more regions based at least in part on the one or more regions being associated with the second amount of data, wherein the one or more regions are updated based at least in part on decompressing the one or more regions.

18. The non-transitory computer-readable medium of claim 14, wherein the instructions are further executable by the processor to:
transfer, from the non-volatile memory to the local memory, additional regions of the address mapping that are associated with the second amount of data, wherein the regions are transferred to the non-volatile memory after transferring the additional regions to the local memory.

19. The non-transitory computer-readable medium of claim 18, wherein the instructions are further executable by the processor to:
determine that a condition for transferring the additional regions has been satisfied, wherein the regions are transferred based at least in part on determining that the condition has been satisfied.

20. A method, comprising:
transferring, from a non-volatile memory to a local memory, regions of an address mapping that are associated with a first amount of data received from a host system;
updating the regions of the address mapping with physical address information for the first amount of data based at least in part on a changelog that indicates physical addresses associated with the first amount of data;
compressing the regions of the address mapping in the local memory based at least in part on updating the regions; and
modifying a bit value to indicate that transfer of the regions to the non-volatile memory is to be delayed until after at least one of the regions has been updated again, wherein the bit value is modified based at least in part on the regions being compressed by a threshold factor.
